(19) United States
(12) Patent Application Publication
(10) Pub. No.: US 2017/0129064 A1
(43) Pub. Date: May 11, 2017

(54) CUTTING TOOL CLEANER

(71) Applicant: FANUC Corporation, Yamanashi (JP)

(72) Inventor: Daisuke UENISHI, Yamanashi (JP)

(21) Appl. No.: 15/293,405

(22) Filed: Oct. 14, 2016

(30) Foreign Application Priority Data
Nov. 9, 2015 (JP) 2015-219208

(51) Int. Cl. B23Q 11/00; G05B 19/402; B23Q 3/157

(52) U.S. Cl. CPC B23Q 11/005; B23Q 3/1572; G05B 19/402; B23Q 2003/15586

(57) ABSTRACT

A nozzle used to clean a cutting tool held by a turret in a position different from a spindle position (cutting tool exchange position) is provided. When a cutting tool exchange command is issued, the turret is caused to pivot so that a cutting tool to be attached to the spindle next is located in a cleaning position. The nozzle ejects a coolant or air toward a cavity in a tapered section of the next cutting tool held by the turret. Since chips and other foreign matter are removed from the cavity, occurrence of clamping failure that may occur when the next cutting tool is attached to the spindle can be avoided.

### BACKGROUND OF THE INVENTION

1. Field of the Invention

The present invention relates to a cutting tool cleaner in a machine tool including a cutting tool exchanger that attaches and detaches a cutting tool to and from a spindle.

2. Description of the Related Art

In a machine tool including a cutting tool exchanger, the cutting tool exchanger automatically exchanges a cutting tool attached to a spindle on the basis of a cutting tool exchange command. The cutting tool is formed of a blade and a blade holder that holds the blade, and the cutting tool is attached to the spindle by inserting and fitting a tapered section of the holder into a tapered insertion hole formed in the end surface of the spindle. However, if foreign matter, such as chips, has adhered to the tapered section of the cutting tool (holder), deflection of the cutting tool occurs due to the foreign matter caught between the spindle and the tapered section of the cutting tool, resulting in machining failure.

In particular, in a compact machine tool, such as a vertical compact machining center, the cutting tool exchanger is typically of a turret-type. In the case of a turret type, since a standby cutting tool is present in the machine tool, chips produced in machining operation enter the turret through a narrow opening and adhere to the standby cutting tool. The chips having adhered to the tapered section of the cutting tool are therefore present between the spindle and the tapered section of the cutting tool, resulting in deflection of the cutting tool. To avoid the situation, Japanese Patent Application Laid-Open Nos. 2002-273640 and 2009-233772, for example, disclose a technique in which a cleaning nozzle is provided, and a coolant or air is ejected through the cleaning nozzle to a cutting tool when the cutting tool is attached to the spindle to remove chips and other foreign matter which have adhered to the surface where the tapered section or any other section of the cutting tool is joined with the spindle, followed by attachment of the cutting tool to the spindle.

In cutting tool cleaning of related art, when the cutting tool is attached to the spindle, a coolant or any other liquid is ejected from the interior or exterior of the spindle to clean the tapered section or any other section of the cutting tool so that chips are removed from the surface where the cutting tool is joined with the spindle. On the other hand, in the case of a cutting tool that complies with CAPT standard, HSK standard, or any other standard, such as the cutting tool shown in FIGS. 1A and 1B, a cavity 4 having a special shape for clamping the cutting tool to the spindle via a clamp mechanism is provided in a tapered section 2 of the cutting tool (cutting tool holder 1). Therefore, in a machine tool including a cutting tool exchanger, such as a turret-type tool exchanger, chips are likely to accumulate in the cavity 4 in the tapered section 2 of the cutting tool.

In a vertical compact machining center, when a cutting tool (cutting tool holder 1) is attached to the spindle, the opening of the cavity 4 in the tapered section 2 of the cutting tool faces upward in the direction of gravity, as shown in FIGS. 1A and 1B (CAPT standard). Therefore, chips, in addition to the coolant ejected to clean the tapered section 2 of the cutting tool, are likely to adhere to the cavity in the tapered section 2. Further, even after the tapered section 2 is cleaned, the chips are likely to accumulate again, due to gravity, in the cavity 4 in the tapered section 2. If the chips adhere to and accumulate in the cavity 4 in the tapered section 2, clamping failure occurs, possibly resulting in machining failure. Therefore, in a turret-type vertical compact machining center, it is difficult to perform stable machining using a CAPT-standard or HSK-standard cutting tool that is more rigid than a BT-standard cutting tool.

### SUMMARY OF THE INVENTION

An object of the present invention is to provide a cutting tool cleaner capable of cleaning a cavity provided in a tapered section of a cutting tool.

A cutting tool cleaner according to the present invention is used in a machine tool including a cutting tool exchanger that attaches and detaches a cutting tool to and from a spindle. The machine tool and the cutting tool exchanger are controlled by a numerical controller. The cutting tool cleaner is attached to the cutting tool exchanger and includes a nozzle used to clean the cutting tool. The nozzle is configured to eject a coolant or air at a location different from a cutting tool exchange position into a tapered section of the cutting tool contained in a cutting tool container of the cutting tool exchanger.

The cutting tool container of the cutting tool exchanger may be formed of a turret that is caused to pivot around a rotary shaft independent of a feed shaft and a spindle of the machine tool.

A cutting tool exchange command in a machining program executed by the numerical controller may be so written as to include, as arguments, a cutting tool number of a cutting tool to be exchanged and a cutting tool number of a cutting tool to be cleaned and attached to the spindle next. The numerical controller may move the cutting tool, specified by the cutting tool exchange command and to be attached to the spindle next, after cutting tool exchange to a position facing the nozzle, read the machining program in advance and determines a machining period from a current machining position to a next cutting tool exchange command to be commanded next, as a remaining period until a next cutting tool exchange, based on a movement distance and a commanded speed during the movement which are commanded by the machining program, and start cleaning of the cutting tool to be attached to the spindle next when the determined remaining period reaches a cutting tool cleaning/return period, which is a sum of a cutting tool cleaning period for which the cutting tool is cleaned and a return period required to cause a holding section of the cutting tool container that receives the cutting tool attached to the spindle to return to a spindle position after the cutting tool is cleaned.

In the numerical controller, the return period may be set for each positional relationship between the holding section of the cutting tool container which holds the cutting tool attached to the spindle and the holding section which holds the cutting tool to be attached to the spindle next, and the cutting tool cleaning period may also be set and stored. The return period determined by the cutting tool currently attached to the spindle and the cutting tool to be attached to the spindle next may be added to the set and stored cutting tool cleaning period to determine the cutting tool cleaning/return period.

The return period may be set to a longest period from among periods required to change a position where one holding section of the cutting tool container faces the spindle position to a position where another holding section faces the spindle position. The cutting tool cleaning period may be added to the thus set return period and the resultant period is set as the cutting tool cleaning/return period.

According to the present invention, since a cavity provided in a tapered section of a cutting tool that complies with CAPT standard, HSK standard, or any other standard is cleaned so that chips and other foreign matter are removed, clamping failure that may occur when the cutting tool is attached to the spindle can be avoided.

### BRIEF DESCRIPTION OF THE DRAWINGS

The forgoing and other objects and feature of the invention will be apparent from the following description of preferred embodiments of the invention with reference to the accompanying drawings, in which:

FIGS. 1A and 1B describe a CAPT-standard cutting tool holder having a cavity in a tapered section, wherein FIG. 1A is a front view and FIG. 1B is a cross-sectional view taken along the center line;

FIGS. 2A to 2D describe a machine tool including a cutting tool cleaner according to a first embodiment of the present invention, wherein FIG. 2A is a front view, FIG. 2B is a side view, FIG. 2C describes the cutting tool cleaner, and FIG. 2D is a side view of the cutting tool cleaner shown in FIG. 2C;

FIGS. 3A to 3D describe a machine tool including a cutting tool cleaner according to a second embodiment of the present invention, wherein FIG. 3A is a front view, FIG. 3B is a side view, FIG. 3C describes the cutting tool cleaner, and FIG. 3D is a side view of the cutting tool cleaner shown in FIG. 3C; and

FIG. 4 is a flowchart showing the flow of a cleaning process carried out by the cutting tool cleaners shown in FIGS. 2C and 2D and FIGS. 3C and 3D.

### DETAILED DESCRIPTION OF THE PREFERRED EMBODIMENTS

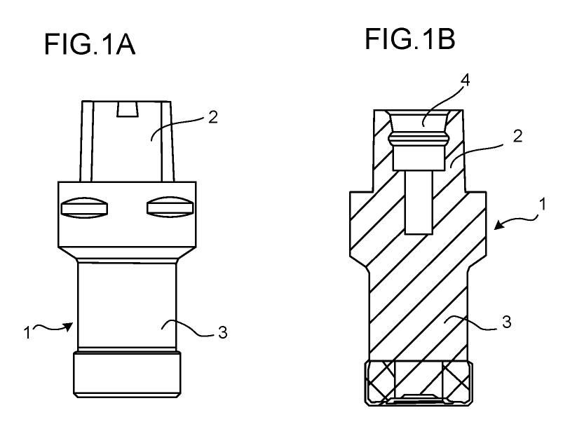

A cutting tool cleaner according to the present invention cleans a cutting tool holder having a clamping cavity provided in a tapered section of the cutting tool holder (cutting tool holder that complies with CAPT standard or HSK standard) and used to attach a cutting tool (cutting tool holder) to the spindle. FIGS. 1A and 1B describe a CAPT-standard cutting tool holder 1 as an example of the cutting tool holder having a cavity in the tapered section.

The cutting tool holder 1 is formed of a tapered section 2 and a blade attachment section 3. A cutting tool (not shown) is attached to the blade attachment section 3, and the tapered section 2 is fit into a tapered hole provided in the spindle and attached to the spindle. A cavity 4, which has a clamping special shape used as a clamp mechanism for attaching a cutting tool to the spindle, is provided in the tapered section 2. Since chips are likely to adhere to and accumulate in the cavity 4, resulting in clamping failure, the present invention provides a cutting tool cleaner capable of cleaning the cavity.

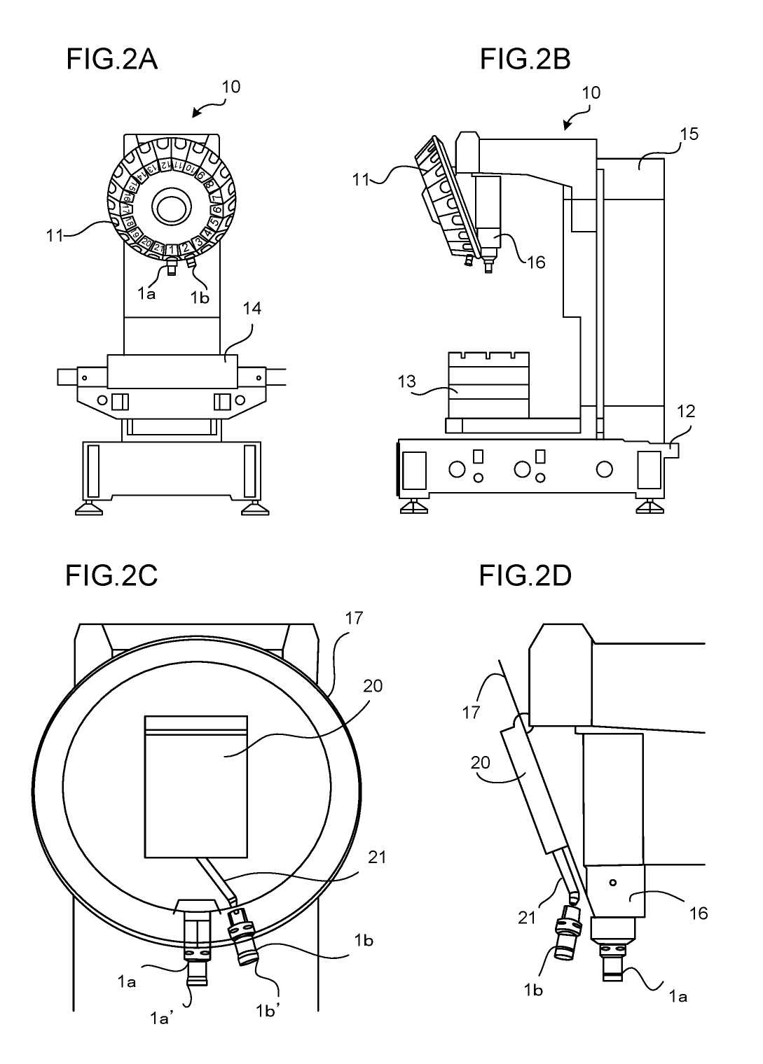

A machine tool including a cutting tool cleaner according to a first embodiment of the present invention will first be described with reference to FIGS. 2A to 2D.

In FIGS. 2A and 2B, reference numeral 10 denotes a machine tool. Reference numeral 11 denotes a turret of a cutting tool exchanger. Reference numeral 12 denotes a bed. Reference numeral 13 denotes a saddle. Reference numeral 14 denotes a table. Reference numeral 15 denotes a column. The turret 11 is allowed to pivot round a shaft independent of feed shafts along which the table 13 and a spindle 16 are moved and a rotary shaft around which the spindle is rotated. The machine tool and the cutting tool exchanger are controlled by a CNC apparatus (computerized numerical controller). The configuration is the same as that of a conventional CNC-controlled machine tool including a turret-type cutting tool exchanger.

The present invention is characterized in that the cutting tool cleaner is attached to the cutting tool exchanger provided in the CNC-controlled machine tool, and the cutting tool cleaner, which cleans the cavity provided in the tapered section of a cutting tool (holder), and a cover 17 are provided on the rear side of the turret 11, as shown in FIGS. 2B and 2C. In FIGS. 2C and 2D, the turret 11 shown in FIGS. 2A and 2B is omitted.

The cutting tool cleaner is formed of a cleaner 20 and a nozzle 21. In the embodiment, the turret 11 is used as a cutting tool container of the cutting tool exchanger, and 21 grips (cutting tool holding sections) each of which holds a cutting tool are provided along the periphery of the turret 11 as the cutting tool container (In FIG. 2A, the turret 11 is labeled with numbers 1 to 21).

The nozzle 21 is so disposed as to eject a coolant or air toward a cutting tool in a cutting tool cleaning position that is a grip position shifted from and immediately adjacent to a grip position facing the spindle 16 (cutting tool exchange position), as shown in FIG. 2C. In FIGS. 2C and 2D, reference symbol 1a denotes a cutting tool attached to the spindle 16, and reference symbol 1b denotes a cutting tool in the grip position (cutting tool cleaning position) shifted from and immediately adjacent to the grip position facing the spindle 16 (cutting tool exchange position). Reference symbols 1a′ and 1b′ denote blades attached to the cutting tools 1a and 1b, respectively. The nozzle 21 of the cutting tool cleaner faces the cavity provided in the tapered section of the cutting tool 1b held by the grip in the grip position shifted from and immediately adjacent to the grip position facing the spindle 16 (cutting tool exchange position), and the coolant or air is ejected through the nozzle 21 into the cavity to clean the cavity.

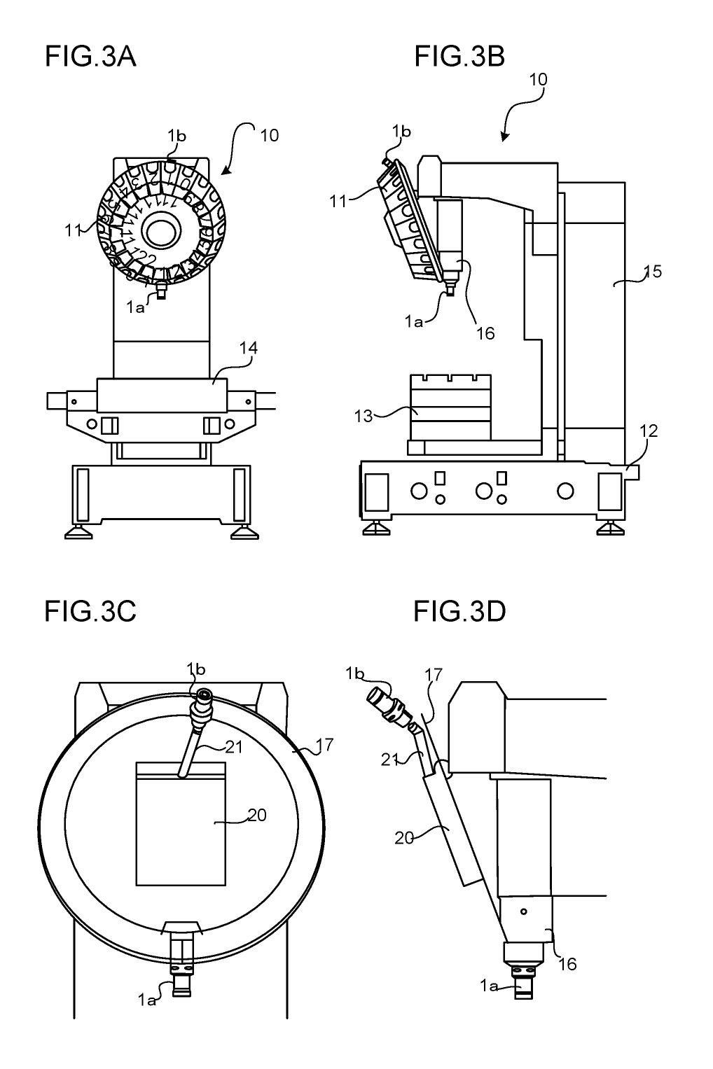

A machine tool including a cutting tool cleaner according to a second embodiment of the present invention will next be described with reference to FIGS. 3A to 3D.

The second embodiment differs from the first embodiment in terms of the eject position and orientation of the nozzle of the cutting tool cleaner. In the second embodiment, the cutting tool cleaning position is the position angularly shifted from the spindle position (cutting tool exchange position) by about 180 degrees, and the cavity of a cutting tool held by the grip in the cutting tool cleaning position is cleaned. That is, the nozzle 21 faces upward, as shown in FIGS. 3C and 3D, and ejects a coolant or air toward the cavity of the cutting tool 1b held by the grip in the position angularly shifted from the spindle position (cutting tool exchange position) by about 180 degrees to clean the cavity.

In the first embodiment, the opening of the cavity 4 in the tapered section of a cutting tool faces upward in the cutting tool cleaning position. Since downward gravity acts on chips and other foreign matter in the cavity, the chips are likely to be left in the cavity in this configuration, for example, in a case where the coolant or air is ejected through the nozzle 21 with poor force. On the other hand, in the second embodiment, in which the opening of the cavity 4 in the tapered section of a cutting tool faces downward in the cutting tool cleaning position, chips in the cavity tend to drop due to the downward gravity, whereby the coolant or air ejected through the nozzle 21 can readily remove the chips out of the cavity.

The position where the coolant or air is ejected through the nozzle 21 (position of cutting tool to be cleaned and held by grip of turret) and the orientation of the nozzle 21 in the ejection operation are not limited to the position and orientation shown in the first and second embodiments described above, and such a position needs only to be a grip position other than the position where the nozzle 21 faces the spindle (cutting tool exchange position).

Cutting tool cleaning action of the cutting tool cleaner according to the first and second embodiments described above will next be described.

The cutting tool cleaning performed by the cutting tool cleaner according to the present invention is cleaning in the form of removal of chips that adhere to and accumulate in the cavity 4 in the tapered section of a cutting tool. In this case, to prevent the chips from adhering to the cavity after a cutting tool to be used next is cleaned, the cutting tool is desirably cleaned immediately before the cutting tool is used. To this end, the timing at which the cutting tool cleaning starts is set to be earlier than the cutting tool exchange timing by a cutting tool cleaning/return period t, which is the sum of a cutting tool cleaning period tc, for which a cutting tool to be used next is cleaned, and a return period tr, which is required to cause the turret to pivot to the position (cutting tool exchange position) where a grip (idle grip) that receives the cutting tool attached to the spindle faces the spindle position so that the cutting tool attached to the spindle is allowed to return to the turret. That is, the cutting tool cleaning/return period t is determined by computing the following Expression (1):

t=tc+tr (1)

To compute the cutting tool cleaning/return period t, the tool cleaning period tc is arbitrarily determined in advance and set in the CNC apparatus, which controls the machine tool and the cutting tool exchanger. The return period tr varies depending on the positional relationship (cutting tool positional relationship) between the turret grip that receives the cutting tool currently attached to the spindle and the turret grip that holds the cutting tool to be attached to the spindle next. The return period tr corresponding to the cutting tool positional relationship is therefore set in the CNC apparatus. The return period tr corresponding to the cutting tool positional relationship is then read, and the cutting tool cleaning period tc set in advance is added to the read return period tr, that is, Expression (1) described above is computed for determination of the cutting tool cleaning/return period t.

On the other hand, a machining program is read in advance so that a machining period t_{L} required to complete machining from the current machining position to the position where next cutting tool exchange starts (the period is called remaining period until the next cutting tool exchange) is determined. The remaining period t_{L} until the next cutting tool exchange is determined by division of lengths of movement Ln (n=1, 2, 3, . . . ) on a commanded speed basis by commanded speeds Fn (n=1, 2, 3, . . . ) and summation of the resultant periods (Ln/Fn) on a commanded speed basis. That is, the following Expression (2) is computed to determine the remaining period t_{L} until the next cutting tool exchange:

t_{L}=L₁/F₁+L₂/F₂+L₃/F₃+ . . . (2)

When the remaining period t_{L} until the next cutting tool exchange becomes shorter than or equal to the cutting tool cleaning/return period t, the cleaning is initiated, and the cleaning of the cutting tool to be attached to the spindle is terminated immediately before the cutting tool exchange.

A cutting tool exchange command that involves cutting tool cleaning in the machining program is assumed to have the format of the following M600 command:

M600T^{##}W^{##}

In the cutting tool exchange command format described above, ‘M600’ represents a cutting tool exchange/cleaning command, ‘T^{##}’ represents the cutting tool number, and ‘W^{##}’ represents the next cutting tool number.

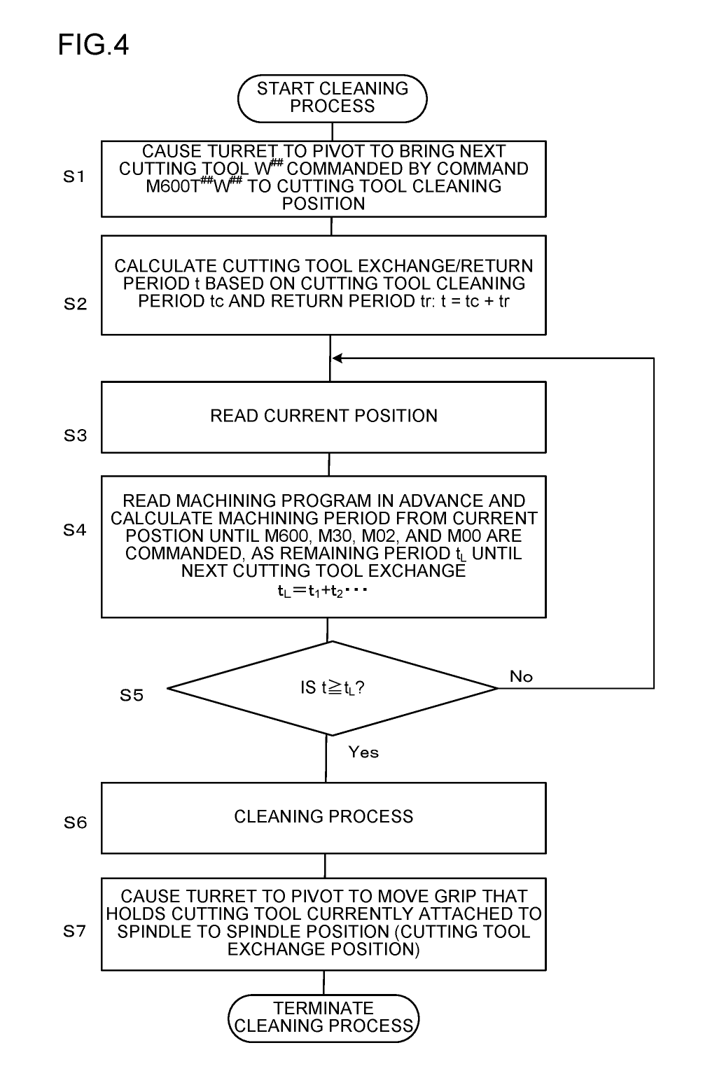

FIG. 4 is a flowchart showing the flow of cleaning processes carried out by the cutting tool cleaner shown in FIGS. 2C and 2D (first embodiment) and FIGS. 3C and 3D (second embodiment) and specifically executed by a processor in the CNC apparatus when the machining program causes the processor to read the cutting tool exchange/cleaning command M600.

The processor in the CNC apparatus reads the machining program and performs machining on the basis of commands in the read machining program. When the machining program causes the processor to read the cutting tool exchange/cleaning command M600T^{##}W^{##}, the processor automatically carries out a cutting tool exchange process of attaching to the spindle a cutting tool having the cutting tool number T^{##} commanded by the read cutting tool exchange/cleaning command, subsequently executes the machining program, and continues the machining until machining termination commands M30, M02, and M00 are read, as in related art.

Further, in the first and second embodiments of the cutting tool cleaner according to the present invention, after the cutting tool is exchanged, the cleaning process shown in FIG. 4 is carried out concurrently with the execution of the machining program.

First, after the cutting tool exchange is completed, the turrets of the cutting tool exchanger are caused to pivot so that a grip to which the next cutting tool number W^{##} is assigned and which is commanded by the cutting tool exchange/cleaning command M600T^{##}W^{##} is brought to the cutting tool cleaning position (step S1). Thereafter, the return period tr, which is set and stored in accordance with the positional relationship between the turret position of the cutting tool having the cutting tool number T^{##} and the turret position of the cutting tool having the next cutting tool number W^{##}, is added to the cutting tool cleaning period tc, which is set in advance, to determine the cutting tool cleaning/return period t (see computation of Expression (1) described above) (step S2).

Thereafter, the current machining position is determined (step S3), the machining program is further read in advance so that the movement distance and the commanded speed are read, and the machining period until the next cutting tool exchange/cleaning command M600 or the machining program termination commands M30, M02, and M00 are issued is calculated as the remaining period t_{L} on the basis of the current machining position determined in step S3. That is, Expression (2) described above is computed to determine the remaining period t_{L} until the next cutting tool exchange (step S4).

The cutting tool cleaning/return period t determined in step S2 is then compared with the remaining period t_{L} until the next cutting tool exchange determined in step S4, and it is evaluated whether or not the remaining period t_{L} until the next cutting tool exchange is shorter than or equal to the cutting tool cleaning/return period t (step S5). In a case where the remaining period t_{L} until next cutting tool exchange is not shorter than or equal to the cutting tool cleaning/return period t, the procedure returns to step S3. The processes in steps S3 to S5 are then repeatedly carried out until the remaining period t_{L} until the next cutting tool exchange becomes shorter than or equal to the cutting tool cleaning/return period t.

As the machining advances, the remaining period t_{L} until the next cutting tool exchange decreases, and when the remaining period t_{L} until the next cutting tool exchange becomes shorter than or equal to the cutting tool cleaning/return period t, the procedure transitions from step S5 to step S6, and the coolant or air is ejected toward the cavity in the cutting tool (cutting tool to be attached to spindle next) having the cutting tool number W^{##} and located in the cutting tool cleaning position to clean the cavity (step S6).

After the cleaning process is completed, the turret 11 is caused to pivot so that the grip that allows the turret to contain the cutting tool having the cutting tool number T^{##} and currently attached to the spindle is brought to the position (cutting tool exchange position) facing the spindle position (step S7), and the current cleaning process is terminated. When the machining program being involved in the machining causes the processor to read the cutting tool exchange/cleaning command M600T^{##}W^{##} again, the cleaning process shown in FIG. 4 is carried out.

As described above, the cavity in the tapered section of a cutting tool to be attached to the spindle in response to the cutting tool exchange/cleaning command M600 is cleaned immediately before the cutting tool is attached to the spindle, whereby occurrence of the clamping failure can be avoided.

In each of the first and second embodiments described above, to clean a cutting tool to be attached next as immediately as possible before cutting tool exchange, the return period tᵣ, which is determined by the positional relationship between the turret grip that holds the cutting tool currently attached to the spindle and the turret grip that holds a cutting tool to be attached to the spindle next, is determined, and the cutting tool cleaning period t_{c} is added to the return period tᵣ to determine the cutting tool cleaning/return period t. Instead, the return period tr may be a fixed period irrespective of the positional relationship. Since the turret rotates both in the forward and reverse directions, the amount of pivotal motion of the turret to the position where the cutting tool currently attached to the spindle is gripped is half a turn at the maximum. Therefore, the return period tᵣ may be set to be equal to the period required for half a turn of the turret, and the return period tᵣ may be added to the cutting tool cleaning period t_{c} to determine the cutting tool cleaning/return period t. In this case, the cutting tool cleaning/return period t is a fixed period, and the fixed period may be set and stored in advance.

As described above, since the present invention allows cleaning of the cavity in the tapered section of a cutting tool, a CAPT-standard or HSK-standard cutting tool, which is more rigid than a BT-standard cutting tool, can be employed even in a turret-type vertical compact machining center, which has not been allowed to employ a CAPT-standard or HSK-standard cutting tool.

1. A cutting tool cleaner used in a machine tool including a cutting tool exchanger that attaches and detaches a cutting tool to and from a spindle,
wherein the machine tool and the cutting tool exchanger are controlled by a numerical controller,
the cutting tool cleaner is attached to the cutting tool exchanger and includes a nozzle used to clean the cutting tool, and
the nozzle is configured to eject a coolant or air at a location different from a cutting tool exchange position into a tapered section of the cutting tool contained in a cutting tool container of the cutting tool exchanger.

2. The cutting tool cleaner according to claim 1, wherein the cutting tool container of the cutting tool exchanger is formed of a turret that is caused to pivot around a rotary shaft independent of a feed shaft and a spindle of the machine tool.

3. The cutting tool cleaner according to claim 1,
wherein a cutting tool exchange command in a machining program executed by the numerical controller is so written as to include, as arguments, a cutting tool number of a cutting tool to be exchanged and a cutting tool number of a cutting tool to be cleaned and attached to the spindle next,
the numerical controller
moves the cutting tool, specified by the cutting tool exchange command and to be attached to the spindle next, after cutting tool exchange to a position facing the nozzle,
reads the machining program in advance and determines a machining period from a current machining position to a next cutting tool exchange command to be commanded next, as a remaining period until a next cutting tool exchange, based on a movement distance and a commanded speed during the movement which are commanded by the machining program, and
starts cleaning of the cutting tool to be attached to the spindle next when the determined remaining period reaches a cutting tool cleaning/return period, which is a sum of a cutting tool cleaning period for which the cutting tool is cleaned and a return period required to cause a holding section of the cutting tool container that receives the cutting tool attached to the spindle to return to a spindle position after the cutting tool is cleaned.

4. The cutting tool cleaner according to claim 3,
wherein in the numerical controller,
the return period is set for each positional relationship between the holding section of the cutting tool container which holds the cutting tool attached to the spindle and the holding section which holds the cutting tool to be attached to the spindle next, and
the cutting tool cleaning period is also set and stored, and
the return period determined by the cutting tool currently attached to the spindle and the cutting tool to be attached to the spindle next is added to the set and stored cutting tool cleaning period to determine the cutting tool cleaning/return period.

5. The cutting tool cleaner according to claim 3,
wherein the return period is set to a longest period from among periods required to change a position where one holding section of the cutting tool container faces the spindle position to a position where another holding section faces the spindle position, and
the cutting tool cleaning period is added to the thus set return period and the resultant period is set as the cutting tool cleaning/return period.
